(19) United States
(12) Patent Application Publication
(10) Pub. No.: US 2014/0097711 A1
(43) Pub. Date: Apr. 10, 2014

(54) ONE PIECE ROTOR HUB/SHAFT FOR AN ELECTRIC MACHINE AND METHOD

(71) Applicant: Larry Kubes, Indianapolis, IN (US)

(72) Inventor: Larry Kubes, Indianapolis, IN (US)

(21) Appl. No.: 13/646,168

(22) Filed: Oct. 5, 2012

(51) Int. Cl. H02K 1/28; H02K 9/00; H02K 5/24

(52) U.S. Cl. 310/51; 310/58; 310/261.1

(57) ABSTRACT

A one piece rotor hub/shaft includes a hub portion having an outer annular surface, an axial end integrally formed with the outer annular surface, and a shaft section extends from, and is integrally formed with, the axial end.

### BACKGROUND OF THE INVENTION

Exemplary embodiments pertain to the art of electric machines and, more particularly, to a one piece rotor hub/shaft for an electric machine.

Electric machines generally include a housing that encloses a rotor and a stator. The rotor typically includes a rotor hub. The rotor hub supports a plurality of rotor windings that, when acted upon by a magnetic field generated by the stator, cause the rotor to rotate. In some cases, the rotor will include laminations that support permanent magnets. The permanent magnets also interact with the magnetic field supplied by the stator causing the rotor to rotate. The rotor hub is joined to a shaft that is supported by one or more bearings. In some cases, the rotor hub may be bonded to the shaft through a welded connection. In other cases, the rotor hub may be bonded to the shaft through a mechanical connection such as through splines, keys, or mechanical fasteners.

### BRIEF DESCRIPTION OF THE INVENTION

Disclosed is a one piece rotor hub/shaft including a hub portion having an outer annular surface, an axial end integrally formed with the outer annular surface, and a shaft section extends from, and is integrally formed with, the axial end.

Also disclosed is an electric machine including a housing, a stator mounted to the housing, and a rotor assembly rotatably mounted to the housing. The rotor assembly includes a one piece hub/shaft having a hub portion including an outer annular surface, an axial end is integrally formed with the outer annular surface, and a shaft section extends from, and is integrally formed with, the axial end.

### BRIEF DESCRIPTION OF THE DRAWINGS

The following descriptions should not be considered limiting in any way. With reference to the accompanying drawings, like elements are numbered alike:

FIG. 1 depicts a cross-sectional side view of an electric machine including a one piece rotor hub/shaft in accordance with an exemplary embodiment;

FIG. 2 depicts a tube inserted into a mold to form the one piece rotor hub/shaft in accordance with an exemplary embodiment;

FIG. 3 depicts the tube after being formed into the one piece rotor hub/shaft in accordance with an exemplary embodiment;

FIG. 4 is a side view of the one piece rotor hub/shaft in accordance with an exemplary embodiment;

FIG. 5 depicts a cross-sectional side view of an electric machine including a one piece rotor hub/shaft in accordance with another aspect of the exemplary embodiment; and

FIG. 6 depicts a cross-sectional side view of an electric machine including a one piece rotor hub/shaft in accordance with yet another aspect of an exemplary embodiment.

### DETAILED DESCRIPTION OF THE INVENTION

A detailed description of one or more embodiments of the disclosed apparatus and method are presented herein by way of exemplification and not limitation with reference to the Figures.

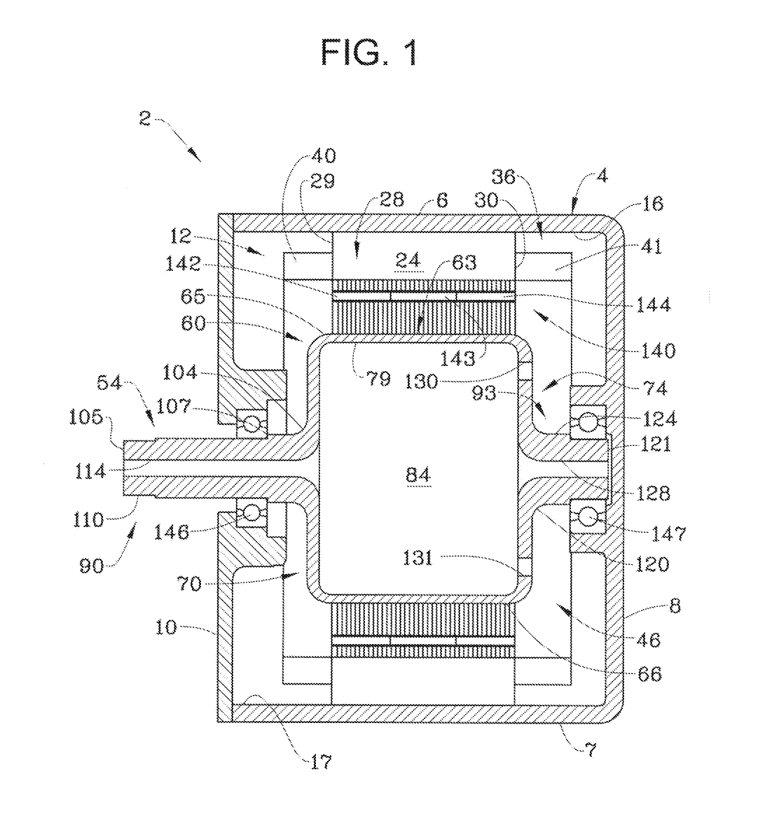

An electric machine in accordance with an exemplary embodiment is indicated generally at 2 in FIG. 1. Electric machine 2 includes a housing 4 having first and second side walls 6 and 7 that are joined by a first end wall 8 and a second end wall or cover 10 to collectively define an interior portion 12. First side wall 6 includes a first inner surface 16 and second side wall 7 includes a second inner surface 17. At this point it should be understood that housing 4 could also be constructed to include a single side wall having a continuous inner surface. Electric machine 2 is further shown to include a stator 24 arranged at first and second inner surfaces 16 and 17 of first and second side walls 6 and 7. Stator 24 includes a body or stator core 28, having a first end portion 29 that extends to a second end portion 30, which supports a plurality of windings 36. Windings 36 include a first end turn portion 40 and a second end turn portion 41.

In accordance with an exemplary embodiment, electric machine 2 is also shown to include a rotor assembly 46 including a one piece rotor hub/shaft 54. One piece rotor hub/shaft 54 includes a hub portion 60 having an outer annular surface 63. Outer annular surface 63 extends from a first end section 65 to a second end section 66. A first axial end 70 is integrally formed with hub portion 60 at first end section 65. A second axial end 74 is integrally formed with hub portion 60 at second end section 66. Hub portion 60 is also shown to include a continuous inner surface 79 that defines an internal cavity 84. Internal cavity 84 may be supplied with a coolant that is configured to reduce temperatures in rotor assembly 46.

A first shaft section 90 extends from, and is integrally formed with, first axial end 70 and a second shaft section 93 extends from, and is integrally formed with, second axial end 74. First shaft section 90 includes a first end 104 that extends from first axial end 70 to a second end 105. A first annular raised boss 107 is provided on first shaft section 90 at first end 104 and a plurality of grooves or splines, one of which is shown at 110, are formed in second end 105. Grooves 110 may be formed by machining, hobbing, or the like. Also, it should be understood that second end 105 may be provided with a single groove for receiving a key (not shown). A first axial passage 114 extends through first shaft section 90 and fluidically connects with internal cavity 84. Second shaft section 93 includes a first end portion 120 that extends from second axial end 74 to a second end portion 121. A second annular raised boss 124 is provided at first end portion 120. A second axial passage 128 extends through second shaft section 93. First axial passage 114 may act as an inlet for a coolant flowing into internal cavity 84. Coolant may flow out from internal cavity 84 through openings 130 and 131 formed in second axial end 74. In the exemplary embodiment shown, second axial passage 128 is blocked preventing the escape of coolant

Outer annular surface 63 supports a plurality of rotor laminations, one of which is indicated at 140. Rotor laminations 140 support permanent magnets 142, 143, and 144. As such, rotor assembly 46 is configured as part of a permanent magnet electric machine. Of course it should be understood that outer annular surface 63 may support rotor windings that interact with stator windings 36 so that rotor assembly 46 may be employed in a wide range of electric machine/motor types. One piece rotor hub/shaft 54 is supported within interior portion 12 through first and second bearings 146 and 147. First bearing 146 supports first shaft section 90 at first raised annular boss 107 and second bearing 147 supports second shaft section 93 at second raised annular boss 124. The incorporation of a one piece rotor hub/shaft 54 into electric machine 2 leads to a reduction in costs for the production of electric machine 2. The one piece rotor hub/shaft 54 also lowers rotor mass. The reduction in rotor mass leads to various performance benefits for electric machine 2.

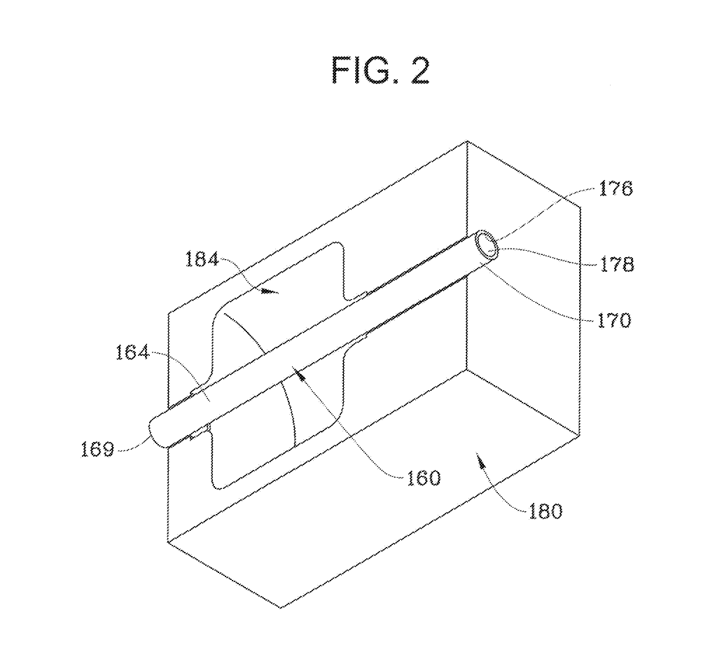

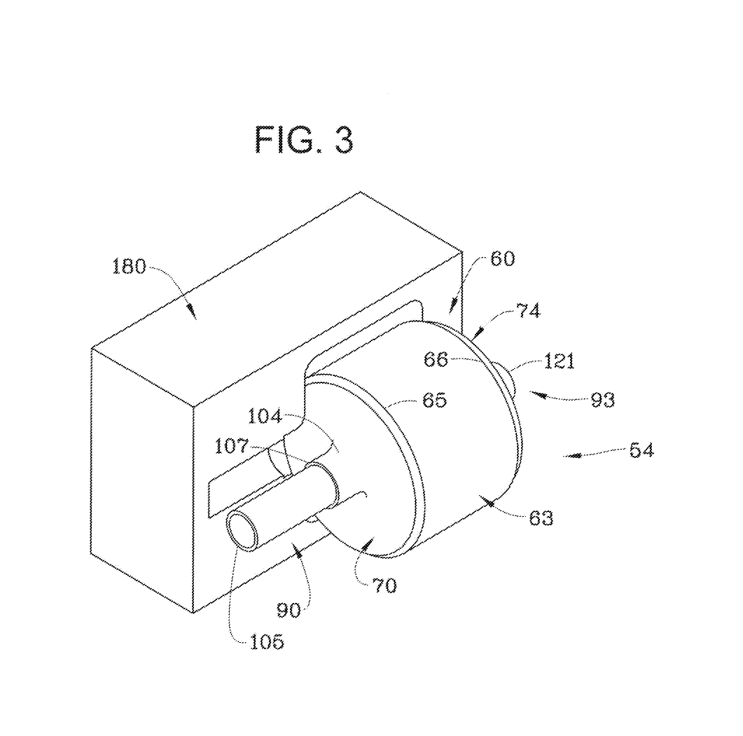

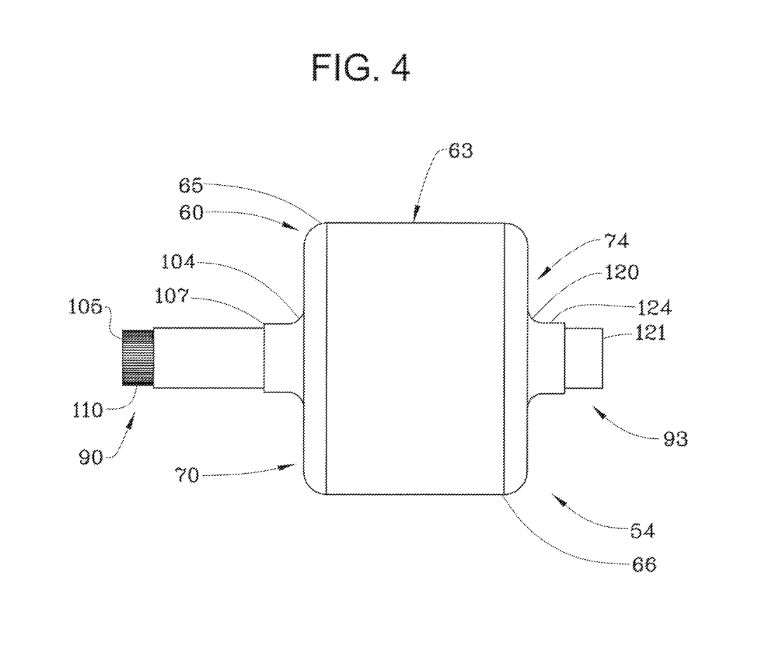

As shown in FIG. 2, one piece rotor hub/shaft 54 is formed from a tube 160. Tube 160 is formed from steel and includes an outer surface 164 extending from a first end 169 to a second end 170. Second end 170 includes an opening 176 that exposes an internal passage 178. First end 169 is closed or plugged to prevent fluid escape as will become more fully evident below. Tube 160 is placed in a mold, a portion of which is indicated at 180. Mold 180 includes an interior profile 184 that represents a negative image of half of one piece rotor hub/shaft 54. A second mold half (not shown) is mated with and joined to mold 180. A pressurized fluid, such as air, is introduced into internal passage 178 through second end 170. The pressurized fluid causes tube 160 to expand such that outer surface 164 closely conforms to interior profile 184 forming one piece rotor hub/shaft 54 such as shown in FIG. 3. One piece rotor hub/shaft 54 is then removed from mold 180 as shown in FIG. 4. A groove or grooves are formed in first shaft section 90 and one piece rotor hub/shaft is finally assembled to form rotor assembly 46.

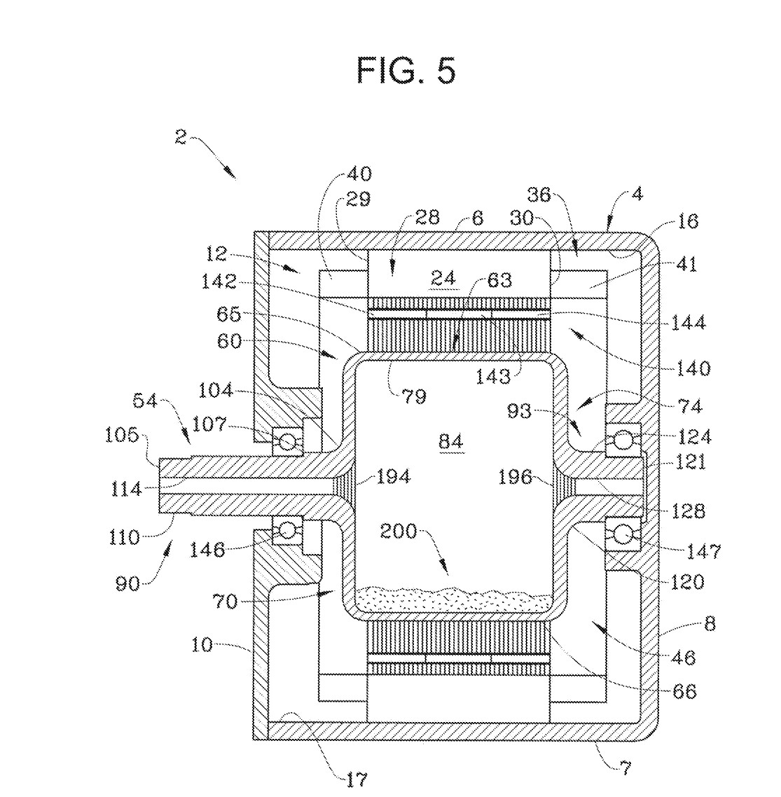

In accordance with another aspect of an exemplary embodiment illustrated in FIG. 5 wherein like reference numbers represent corresponding parts in the respective views, both first and second axial passages 114 and 128 are blocked by first and second plugs 194 and 196, and hub portion 60 is devoid of openings. In the exemplary embodiment shown, internal cavity 84 is provided with a balancing medium 200. Balancing medium 200 may take the form of a liquid or a solid, such as a powder, that moves with one piece rotor hub/shaft 54. Balancing medium 200 moves to a particular area of hub portion 60 in order to counteract any out-of-balance condition that may exist in one piece rotor hub/shaft 54.

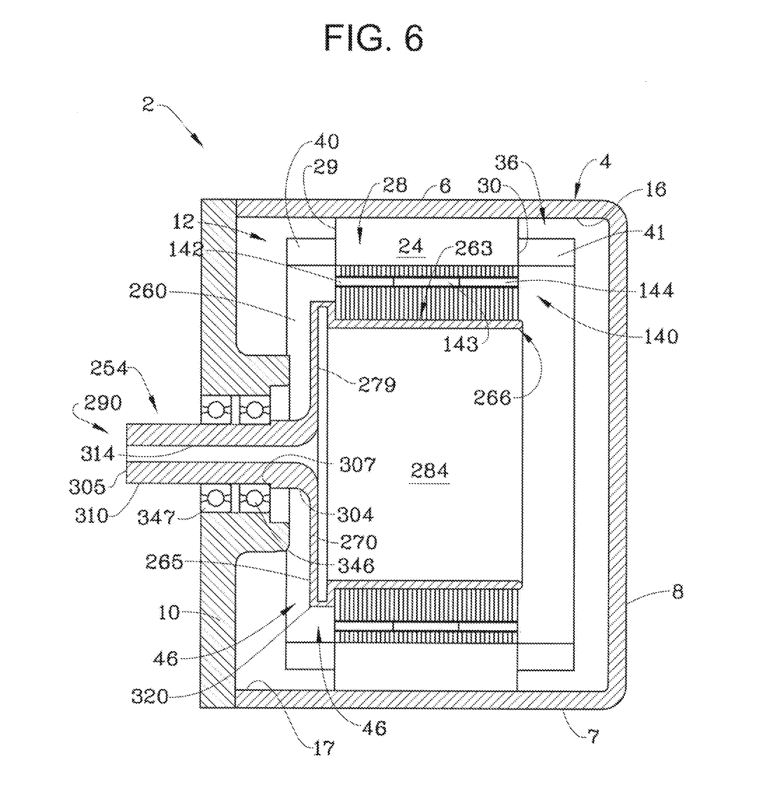

FIG. 6, wherein like reference numbers represent corresponding parts in the respect views, illustrates a one piece rotor hub/shaft 254 in accordance with another aspect of the exemplary embodiment. One piece rotor hub/shat 254 includes a hub portion 260 having an outer annular surface 263. Outer annular surface 263 extends from a first end section 265 to a second, cantilevered, end section 266. A first axial end 270 is integrally formed with hub portion 260 at first end section 265. Hub portion 260 is also shown to include a continuous inner surface 279 that defines an internal cavity 284 that is open at second, cantilevered end 266.

A shaft section 290 extends from, and is integrally formed with, first axial end 270. Shaft section 290 includes a first end 304 that extends from first axial end 270 to a second end 305. An annular raised boss 307 is provided on shaft section 290 at first end 304 and a plurality of grooves or splines, one of which is shown at 310, are formed in second end 305. Grooves 310 may be formed by machining, hobbing, or the like. Also, it should be understood that second end 305 may be provided with a single groove for receiving a key (not shown). An axial passage 314 extends through shaft section 290 and fluidically connects with internal cavity 284.

Outer annular surface 263 supports a plurality of rotor laminations, one of which is indicated at 140. Outer annular surface 263 is also shown to include a balancing ring 320. Balancing ring 320 may be selectively adjusted through the removal or addition of material to establish a desired balance for one piece rotor hub/shaft 254. One piece rotor hub/shaft 254 is supported within interior portion 12 through first and second bearings 346 and 347 provided in second end portion 10. First bearing 346 supports shaft section 290 at a raised annular boss 307 and second bearing 347 is positioned adjacent to first bearing 346. One piece rotor hub/shaft 254 is formed from a tube in a manner similar to that described above. However, once formed, the tube is divided to form a first one piece rotor hub/shaft 254 and a second one piece rotor hub/shaft (not shown). In this manner, manufacturing and assembly of electric machine 2 may be simplified. Further, the use of one piece rotor hub/shaft 254 may lead to a reduced overall footprint for electric machine 2.

At this point it should be understood that the exemplary embodiments provide a one piece or unitary rotor hub/shaft for an electric machine. The one piece rotor hub/shaft is hydroformed or formed by introducing a pressurized fluid into a tube. The tube is caused to expand and take on a shape of a rotor hub with an integral shaft. In addition to creating the unitary rotor hub/shaft, hydroforming creates internal voids that may provide passage for cooling fluid, or act as a receptacle for a balancing medium The unitary rotor hub/shaft provides various cost and manufacturing benefits as well as an increase in motor performance. Further, by eliminating multiple joints, connections, and components, the one piece rotor hub/shaft leads to a reduction in maintenance costs. It should also be understood that while the pressurized fluid is described as being a gas, such as air, other pressurized fluids including liquids may also be employed. Further, while described as being formed from steel, the one piece rotor hub/shaft may be formed from other materials.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A one piece rotor hub/shaft comprising:
a hub portion including an outer annular surface, an axial end integrally formed with the outer annular surface;
a shaft section extending from, and integrally formed with, the first axial end.

2. The one piece rotor hub/shaft according to claim 1, wherein the first shaft section includes a first end that extends from the first axial end to a second end, the first end including an annular raised boss.

3. The one piece rotor hub/shaft according to claim 2, further comprising:
another axial end integrally formed with the outer annular surface opposite the axial end, and another shaft section extending from, and integrally formed with, the another axial end.

4. The one piece rotor hub/shaft according to claim 3, wherein the second end of the shaft section includes one or more grooves.

5. The one piece rotor hub/shaft according to claim 3, wherein the another shaft section includes a first end portion that extends from the another axial end to a second end portion, the first end portion including an annular raised boss.

6. The one piece hub/shaft according to claim 3, wherein the hub portion includes an internal cavity.

7. The one piece hub/shaft according to claim 6, further comprising: a balancing medium provided within the internal cavity.

8. The one piece hub/shaft according to claim 6, wherein the shaft section includes a first axial passage and the another shaft section includes a second axial passage, each of the first and second axial passages being fluidically connected with the internal cavity.

9. The one piece hub/shaft according to claim 6, wherein one of the axial end and the another axial end includes one or more openings configured and disposed to pass coolant from the internal cavity.

10. The one piece hub/shaft according to claim 1, wherein the outer annular surface includes a first end extending from the axial end to a second, cantilevered end.

11. The one piece hub/shaft according to claim 1, further comprising: a balancing ring projecting from the outer annular surface at the axial end.

12. An electric machine comprising:
a housing;
a stator mounted to the housing;
a rotor assembly rotatably mounted to the housing, the rotor assembly including a one piece rotor hub/shaft having a hub portion including an outer annular surface, an axial end integrally formed with the outer annular surface, and a shaft section extending from, and integrally formed with, the axial end.

13. The electric machine according to claim 12, wherein the shaft section includes a first end that extends from the axial end to a second end, the first end including an annular raised boss.

14. The electric machine according to claim 13, wherein the second end of the shaft section includes one or more grooves.

15. The electric machine according to claim 12, further comprising: a another axial end integrally formed with the outer annular surface opposite the axial end, and another shaft section integrally formed with and extending from the another axial end, the second shaft section including a first end portion that extends from the another axial end to a second end portion, the first end portion including an annular raised boss.

16. The electric machine according to claim 12, wherein the hub portion includes an internal cavity.

17. The electric machine according to claim 16, further comprising: a balancing medium provided in the internal cavity.

18. The electric machine according to claim 16, wherein one of the axial end and the another axial end includes one or more openings configured and disposed to pass coolant from the internal cavity.

19. The electric machine according to claim 12, wherein the outer annular surface includes a first end extending from the axial end to a second, cantilevered end.

20. The electric machine according to claim 12, further comprising: a balancing ring projecting from the outer annular surface at the axial end.
